(19) United States
(12) Patent Application Publication
(10) Pub. No.: US 2014/0263465 A1
(43) Pub. Date: Sep. 18, 2014

(54) SEED METERING WHEEL ASSEMBLY

(71) Applicant: USC, L.L.C., Sabetha, KS (US)

(72) Inventor: Jim Renyer, Sabetha, KS (US)

(73) Assignee: USC, L.L.C., Sabetha, KS (US)

(21) Appl. No.: 13/830,083

(22) Filed: Mar. 14, 2013

(51) Int. Cl. B65G 65/48; B65D 88/54

(52) U.S. Cl. CPC B65G 65/48; B65D 88/54
USPC 222/352; 414/304

(57) ABSTRACT

An improved seed metering wheel assembly is provided to deliver a substantially constant flow of seed to a downstream treating device or the like, without any substantial surging of seeds. The seed metering wheel assembly includes an axially rotatable metering wheel having a plurality of strategically sized and arranged seed metering openings therethrough, preferably arranged in circular arrays of differently sized metering openings. Incoming seed is delivered from a seed hopper outlet by gravitation to the metering wheel, which preferably provides a substantially constant open area while preventing wholly unobstructed flow of seeds.

### BACKGROUND OF THE INVENTION

1. Field of the Invention

The present invention is concerned with improved seed metering wheel assemblies, which substantially eliminate surges of seed during operation of a seed treater. More particularly, the invention is concerned with such wheel assemblies, and corresponding methods, wherein a rotatable metering wheel assembly is located beneath a seed hopper and has strategically sized and oriented metering openings therethrough. The openings are preferably of different sizes and are arranged in circular arrays so that a substantially constant volumetric and weight output flow of seeds is achieved.

2. Description of the Prior Art

Coating of agricultural seeds is a common practice in sophisticated farming operations. Thus, seeds have been coated with herbicides, fungicides, absorbents, fertilizers, or other chemicals. Generally, specialized seed treaters are used for these purposes and include an inlet hopper, a seed coating device, and a downstream rotatable dryer. A seed metering device is usually provided between the seed hopper and seed coating device, in an effort to give a substantially constant output flow of seeds to the coating device. However, some prior seed metering devices are prone to surging and inconsistent seed flow, which can lead to over- and undercoating of seeds. The problem of seed surging is significant because the usage rate of coating materials normally does not vary once the treater reaches a steady state condition. Accordingly, when a surge occurs, the quantity of seed delivered to the coater is not matched with the supply and application rates of the coating chemicals. Therefore, the seed treater necessarily produces substantial quantities of under-coated seeds.

U.S. Pat. No. 4,465,017 describes a seed coating device having a typical seed metering wheel of spoked design in the form of a circular, axially rotatable wheel having a series of radial spokes extending from a central hub to the rim of the wheel. Metering wheels of the type described in the '017 patent are subject to surging in instances where an unobstructed flow path is presented, which allows a greater rate of seed flow to the downstream coating apparatus.

In order to ameliorate the effects of seed surging, downstream flow-equalizing devices have been employed, which significantly improve the operation of simple seed wheels. However, these accessories add expense and complexity to the metering equipment

There is accordingly a need in the art for an improved seed metering wheel assembly which is capable of delivering substantially constant flows of seed over a given time period by the essential elimination of undesirable seed surging, without the need for downstream flow equalization devices.

### SUMMARY OF THE INVENTION

The present invention overcomes the problems outlined above, and provides improved seed metering wheel assemblies operable to deliver substantially constant flows of seed over a seed treatment time period of at least about 30 minutes. Broadly, the seed treaters of the invention each include a hopper assembly including a lower seed outlet opening of predetermined shape and size, so that the hopper assembly is operable to hold a supply of seeds and to deliver by gravitation quantities of the seed to the seed outlet opening over the time period. An axially rotatable seed metering wheel assembly is located beneath the seed outlet opening of the hopper and is oriented to receive the quantities of seed and to create a substantially uniform output flow of the seeds. The rotatable metering wheel forming a part of the overall assembly includes a plurality of seed metering openings therethrough and defined by corresponding rib sections. In preferred practice, the rib sections and openings are oriented to present a substantially constant open area beneath the hopper seed outlet opening over the coating period, with at least certain portions of the seed metering opening-defining ribs extending across the seed outlet opening over substantially all of the coating period, in order to prevent wholly unobstructed flow of seeds from the seed outlet opening through the seed metering wheel assembly. Advantageously, at least certain of the seed metering openings are of a size different than the size of others of the seed metering openings. In one embodiment, the seed metering openings are located in a plurality of individual circular arrays each having identically sized openings within the array.

The invention also provides methods for metering quantities of seed by delivering through gravitation quantities of seed from a seed outlet opening to a metering station having a seed metering wheel in accordance with the invention. At the metering station, successive quantities are passed through a series of seed metering openings defined by corresponding rib sections and rotating about an axis, so that the rib sections and seed metering openings present a substantially constant open area during seed metering, and with at least certain portions of the seed metering opening-defining ribs extending across said seed metering openings in order to prevent wholly unobstructed flow of seeds from the outlet opening and through the seed metering openings.

As used herein, a “substantially constant open area” refers to maintaining, at substantially all times, a predetermined open area A, and up to plus or minus 10% of A (more preferably plus or minus 5%), through the seed metering wheel assembly. For example, if a predetermined open area is 10 square inches, a substantially constant area would be from 9-11 square inches. In like manner, a “substantially constant” flow of seeds from the seed metering wheel assembly would encompass a preselected flow rate F and plus or minus 10% of F (more preferably plus or minus 5%).

### BRIEF DESCRIPTION OF THE DRAWINGS

FIG. 1 is a perspective view of a seed treater apparatus having the seed metering wheel assembly of the invention mounted thereon;

FIG. 2 is a perspective view of the seed metering wheel assembly and seed delivery shoot forming a part of the seed treater apparatus;

FIG. 3 is a plan view of the apparatus illustrated in FIG. 2;

FIG. 4 is a vertical sectional view taken along the line 4-4 of FIG. 3;

FIG. 5 is a vertical sectional view taken along the line 5-5 of FIG. 3;

FIG. 6 is a top perspective view of the preferred seed metering wheel assembly of the invention;

FIG. 7 is a bottom perspective view of the seed metering wheel assembly illustrated in FIG. 6;

FIG. 8 is an exploded perspective view of the seed metering wheel assembly; and

FIG. 9 is an exploded perspective view of the apparatus depicted in FIGS. 2-5.

### DETAILED DESCRIPTION

Turning now to the drawings, a complete seed treater 10 is depicted in FIG. 1 and is equipped with a seed metering wheel assembly 12 in accordance with the invention. Generally speaking, the treater 10 is designed to receive incoming quantities of seed, to apply one or more chemicals onto the surfaces of the seeds, and to thereupon dry the seeds. The illustrated seed treater 10 has the assembly 12 which directs seed into an atomizer 14 where the seeds are coated with chemical(s). The preferred atomizer is described in U.S. Pat. Nos. 6,551,402 and 6,783,082, incorporated by reference herein. The coated seeds are then dried within a downstream rotating drum dryer 16, and the finished seeds are delivered by way of outlet 18 for storage or use.

The seed metering wheel assembly 12 broadly includes an uppermost hopper assembly 20, an intermediate metering assembly 22, a lower plate assembly 23, and a lowermost delivery chute 24, which is secured to the inlet end of atomizer 14.

The hopper assembly 20 includes a housing 26 having an upright tubular sidewall 27, circular upper and lower connection flanges 28 and 36, a pair of opposed vents 32, and a series of removable access plates 54. A unitary seed-receiving hopper 34 having a connection flange 36 is positioned within the confines of housing 26, such that the flanges 36 and 30 mate and are connected via fasteners (not shown). The hopper 34 has an arcuate center line apex 38 with identical, downwardly extending, arcuate wall sections 40 and 42 each equipped with an identical, generally triangularly-shaped seed outlet opening 44 or 46; the latter have downwardly extending, defining wall structures 48 or 50. If desired, a tubular extension 55 (FIG. 1) may be attached to the upper end of housing 26 in order to increase the effective volume of the hopper assembly 20.

The seed metering assembly 22 is positioned below hopper assembly 20 and includes a stationary, tubular housing 56 with upper and lower connection flanges 58 and 60. The upper flange 58 of housing 56 mates with lower flange 30 of assembly 20, with appropriate fasteners serving to connect the flanges. The housing 56 supports a stationary channel 62, which in turn supports an electrical drive motor 64 and gear box 66. The channel 62 also supports a pair of outboard brackets 68 and 70 at the central region thereof. A pair of identical, generally triangular weldments 71 are respectively connected to the brackets 68 and 70 and extend outwardly and are supported by the housing 56. The weldments 71 each include a pair of diverging box sidewalls 72, 74 and 80, 82, as well as an outboard spacer 75 or 83, and fasteners 76, 78 or 84, 86. Seed sensors 88 and 90 are respectively connected with box sidewalls 72 and 80. A lowermost, radially extending brush 92 is secured to sidewall 74, and an identical brush 94 is secured to sidewall 82. It will be observed that the weldments 71 each define a substantially triangular through-opening 96 or 98, and are respectively in registry with the seed outlet openings 44 and 46 of hopper assembly 20. It will thus be appreciated that the openings 96, 98 are seed entrance openings for the metering assembly 22.

The overall metering assembly 22 also includes an axially rotatable metering wheel 100, which is situated within the confines of housing 56. The wheel 100 is of composite design (see FIG. 8) and has a series of interconnected, apertured plates, namely an upper synthetic resin wheel plate 102, an intermediate stainless steel reinforcing plate 104, and a lower synthetic resin plate 106. A circumscribing, upwardly extending seed retaining ring 108 surrounds the apertured plates and extends above the upper surface of plate 102. The interconnected plates 102-106 have a central, hexagonal drive opening 109 and a series of seed metering openings 110 therethrough. In detail, the openings 110 are arranged in a total of three circular arrays 112, 114, and 116. The inner array 116 has a plurality of identical, truncated triangular through openings 118; the intermediate array 114 has a plurality of identical, elongated, arcuate openings 120, which are in staggered relationship relative to the openings 118. Finally, the outer array 112 has another series of identical, elongated arcuate openings 122, which are staggered relative to the openings 120 of the intermediate array. It will further be observed that the openings 118, 120, and 122 are each defined by circumscribing rib sections 118a, 120a, and 122a.

The metering wheel 100 is rotated in a clockwise direction, as viewed in FIG. 4, by means of the motor 64 and gear box 66. The box 66 has an elongated, hexagonal, vertically extending, rotatable drive shaft 124 with a lowermost, downwardly extending threaded shank 124a extending below the wheel 100. The shaft 124 and hub 125 serve to rotate the wheel 100, with the shaft 124 received within the central drive opening 109. The operation of motor 64 is controlled by means of conventional wiring including electrical leads 126 and junction box 128 connected to a digital controller (not shown).

Plate assembly 23 is stationary and includes an upper metallic wear plate 130 which engages the lower surface of wheel 100, a synthetic resin foam support pad 132, and a lowermost metallic floor plate 134. The plates 130 and 132 have identical, opposed, outwardly diverging slots 136 and 138, whereas plate 134 has similarly configured through openings 140. The wear plate 130 has a pair of downwardly extending flanges 131 adjacent the edges of openings 136, which direct seed downwardly as the seed exits the assembly 23. The assembly 23 is mounted on shank 124a, and an elongated bearing plate 142, washer 144, and nut 146 are used to mount the assembly 23.

The delivery chute 24 is generally frustoconical and has an uppermost connection flange 150, a tapered hollow body section 152 and a lowermost connection flange 154. The flange 150 is connected to the underside of the plate assembly 23 (with optional use of a spacer ring 156) by means of elongated connectors 158.

As is evident from the foregoing description, the seed metering wheel assembly 12 provides a hopper for receiving seeds to be treated, with the seeds flowing by gravitation through the seed outlet openings 44 and 46, and then through the underlying weldment openings 96 and 98 where the seeds encounter the metering wheel 100. After passage through the metering wheel 100, the seeds pass through the stationary openings 136, 138, and 140 of plate assembly 23, and are finally directed into and through the delivery chute 24 to the atomizer 14 of treater 10.

The passage of seed through the metering wheel 100 is of prime importance. That is, as the wheel 100 rotates, the especially designed and configured seed metering openings 118, 120, and 122, and the corresponding opening-defining rib sections 118, 120a, and 122a continually present a substantially constant open area. That is to say, at virtually every each instant over a given time period, the wheel 100 gives an effective through opening, which is of substantially constant area. Furthermore, owing to the preferred, differently sized openings 118-122, the staggered orientation thereof, and the locations of the defining rib sections 118a-122a, at no instant is there a wholly unobstructed seed flow path through the wheel 100. As such, the tendency of prior spoke-type seed metering wheels to cause a buildup of seed, followed by presentation of a completely unobstructed seed flow path with consequent surging or “dumping” of seed, is substantially eliminated. The presence of the stationary brushes 92 and 94 assists in the desirable operation of the metering wheel 100, by acting as a leveling device in order to successively level the upper surfaces of quantities of seeds retained by the ring 108, so that substantially constant seed weights are present at the inlet face of the metering wheel 100. Consequently, the seed metering wheel assembly 12 of the invention provides a substantially constant weight and volumetric flow of seed to the downstream seed treater.

I claim:

1. A seed metering wheel assembly operable to deliver a substantially constant flow of seed over a time period and comprising:
a hopper assembly including a seed outlet opening of predetermined shape and size, said hopper assembly operable to hold a supply of seeds and to deliver by gravitation quantities of the seed to said seed outlet opening over said time period;
a seed metering wheel assembly located beneath said seed outlet opening and oriented to receive said quantities of seed and to create an output flow of seeds, said seed metering wheel assembly including a rotatable seed metering wheel having a plurality of seed metering openings therethrough and defined by corresponding rib sections,
said rib sections and openings oriented to present a substantially constant open area beneath said seed outlet opening over said period of time, with at least certain portions of said seed metering opening-defining ribs extending across said seed outlet opening over said period of time, in order to prevent wholly unobstructed flow of seeds from said seed outlet opening through the seed metering wheel assembly.

2. The assembly of claim 1, said hopper including a pair of opposed seed outlet openings.

3. The assembly of claim 1, at least certain of said seed metering openings being of a size different than the size of others of the seed metering openings.

4. The assembly of claim 1, said seed metering openings being located in substantially circular arrays, with the openings of each array being of a size different than the openings in an adjacent array.

5. The assembly of claim 4, said seed metering openings being located in respective, first, second, and third circular arrays each having identically sized openings within the arrays, the openings of said first array being adjacent the rotational axis of the seed metering wheel, the openings of said second array being larger than the openings of the first array and located outboard of the first array, and the openings of said third array being larger than the openings of the second array and located outboard of the second array.

6. The assembly of claim 1, there being a seed leveling device adjacent said hopper outlet and above said seed metering wheel assembly in order to successively level the upper surfaces of quantities of seed entering said seed wheel metering assembly.

7. The assembly of claim 6, said seed leveling device comprising a brush adjacent said seed outlet opening.

8. The assembly of claim 1, including a plate assembly disposed across said seed outlet openings, said plate assembly having a plurality of seed passageways therethrough, said plate assembly located beneath said seed metering openings for passage of said flow of seeds from the seed metering wheel assembly.

9. The assembly of claim 8, said seed passageways including a pair of relatively large, opposed passageways.

10. A method of metering quantities of seed in order to create a substantially constant flow of seed over a period of time, said method comprising the steps of:
delivering by gravitation quantities of seed from a seed outlet opening to a metering station; and
at said metering station, successively passing said quantities of seed through a series of seed metering openings defined by corresponding rib sections and rotating about an axis, so that the rib sections and seed metering openings present a substantially constant open area over said period of time, with at least certain portions of the seed metering opening-defining ribs extending across said seed metering openings in order to prevent wholly unobstructed flow of seeds from said outlet opening and through said seed metering openings over said period of time.

11. The method of claim 10, at least certain of said seed metering openings being of a size different than the size of others of the seed metering openings.

12. The method of claim 10, said seed metering openings being located in substantially circular arrays, with the openings of each array being of a size different than the openings in an adjacent array.

13. The method of claim 12, said seed metering openings being located in respective, first, second, and third circular arrays each having identically sized openings within the arrays, the openings of said first array being adjacent the rotational axis of the seed metering openings, the openings of said second array being larger than the openings of the first array and located outboard of the first array, and the openings of said third array being larger than the openings of the second array and located outboard of the second array.

14. The method of claim 10, including the step of leveling the upper surfaces of quantities of seed above said seed metering openings.

15. The method of claim 14, said leveling step comprising the step of brushing the upper surfaces of said quantities of seed.

16. A seed metering wheel assembly operable to deliver a flow of seed over a time period and comprising:
a hopper assembly including a seed outlet opening of predetermined shape and size, said hopper assembly operable to hold a supply of seeds and to deliver by gravitation quantities of the seed to said seed outlet opening over said time period; and
a seed metering wheel assembly located beneath said seed outlet opening and oriented to receive said quantities of seed and to create an output flow of seeds, said seed metering wheel assembly including a rotatable seed metering wheel having a plurality of seed metering openings therethrough and defined by corresponding rib sections,
at least certain of said seed metering openings being of a size different than the size of others of the seed metering openings.

17. The assembly of claim 16, said seed metering openings being located in a plurality of circular arrays each having identically sized openings within the array.

18. The assembly of claim 17, said seed metering openings being located in respective, first, second, and third circular arrays each having identically sized openings within the array, the openings of said first array being adjacent the rotational axis of the seed metering wheel, the openings of said second array being larger than the openings of the first array and located outboard of the first array, and the openings of said third array being larger than the openings of the second array and located outboard of the second array.
